(19) United States
(12) Patent Application Publication
(10) Pub. No.: US 2013/0248102 A1
(43) Pub. Date: Sep. 26, 2013

(54) METHOD OF MANUFACTURING MICROCHIP

(71) Applicant: ALPS ELECTRIC CO., LTD., Tokyo (JP)

(72) Inventors: Yoshinao Taniguchi, Miyagi-Ken (JP); Yoshinao Taguchi, Miyagi-Ken (JP); Hiroyuki Sugimura, Kyoto (JP); Young-Jong Kim, Kyoto (JP)

(73) Assignee: ALPS ELECTRIC CO., LTD., Tokyo (JP)

(21) Appl. No.: 13/904,273

(22) Filed: May 29, 2013

Related U.S. Application Data
(63) Continuation of application No. PCT/JP2011/068512, filed on Aug. 15, 2011.

(30) Foreign Application Priority Data
Dec. 6, 2010 (JP) 2010-271253

(51) Int. Cl. B32B 37/06

(52) U.S. Cl. CPC B32B 37/06
USPC 156/272.2

(57) ABSTRACT

In a method of manufacturing a microchip that has a pair of resin base materials of which facing surfaces are bonded to each other and that has a concave portion formed in at least one of the facing surfaces, the facing surfaces before the pair of resin base materials are bonded to each other are irradiated with ultraviolet light which is light having a wavelength of an ultraviolet region, and the ultraviolet light-irradiated facing surfaces of the pair of resin base materials are irradiated with visible light that substantially includes light having a wavelength of a visible region.

### CLAIM OF PRIORITY

This application is a Continuation of International Application No. PCT/JP2011/068512 filed on Aug. 15, 2011, which claims benefit of priority to Japanese Patent Application No. 2010-271253 filed on Dec. 6, 2010. The entire contents of each application noted above are hereby incorporated by reference.

### BACKGROUND

1. Field of the Invention

The present invention relates to a method of manufacturing a microchip having a fine flow channel and a circuit formed therein, particularly, a microchip with reduced fluorescence, which is used in fields such as chemistry, biochemistry, and medicine.

2. Description of the Related Art

In fields such as chemistry, biochemistry, and medicine, when a chemical reaction, separation, analysis, detection, and the like are required in a space of a fine flow channel, a microchip, having a fine flow channel and a circuit formed therein, is formed on a silicon substrate or a glass substrate. However, in a method of performing microfabrication on an inorganic material such as silicon or glass, there is a problem in that the method is not suitable for, particularly, one-time disposable use because of a high manufacturing cost and a long manufacturing time.

For this reason, as shown in FIG. 9, Japanese Unexamined Patent Application Publication No. 2006-187730 discloses a method of manufacturing a microchip using a pair of resin substrates in which a fine flow channel is formed. In the method of manufacturing a microchip, first, as shown in FIG. 9(a), surfaces of a resin substrate 903 having a groove 905 of a fine flow channel formed in the surface thereof, and a resin cover substrate 904 which are to be bonded to each other are irradiated with vacuum ultraviolet light 911 from a vacuum ultraviolet light source 910 to thereby form a surface modification layer 907 on the surface of the resin substrate 903 and form a surface modification layer 908 on the surface of the resin cover substrate 904. Next, as shown in FIG. 9(b), the surface modification layer 907 and the surface modification layer 908 are caused to face each other so as to be superimposed on each other, and then the both substrates are bonded to each other by heating and pressing. Thereby, it is possible to easily manufacture a microchip which is excellent in the cross-section structure stability of the flow channel, pressure resistance and the like, through a simple method and at low cost.

However, in the manufacturing method as disclosed in the example of the related art, ultraviolet light is used in the adhesion of the pair of resin substrates, and thus fluorescence is generated on the surfaces of the resin substrates irradiated with the ultraviolet light. For this reason, in fluorescence labeling that performs measurement by applying a fluorescent marker to a specimen, if the microchip is used, there is a problem in that the fluorescence generated on the surfaces of the resin substrates has an adverse effect on the measurement and thus detection accuracy decreases. On the other hand, when an adhesive is used in the adhesion of the pair of resin substrates, the adhesive itself includes a large amount of material that produces fluorescence, and thus there is a problem in that the adhesive has a larger adverse effect on the measurement than the microchip that is created by the irradiation with ultraviolet light.

### SUMMARY

A method of manufacturing a microchip that has a pair of resin base materials of which facing surfaces are bonded to each other and that has a concave portion formed in at least one of the facing surfaces, the method includes: irradiating the facing surfaces before the pair of resin base materials are bonded to each other, with ultraviolet light which is light having a wavelength of an ultraviolet region, and then irradiating the ultraviolet light-irradiated facing surfaces of the pair of resin base materials, with visible light that substantially includes light having a wavelength of a visible region.

Accordingly, in the method of manufacturing a microchip of the present invention, fluorescent molecules with a fluorescent property which are generated by ultraviolet light are in an excited state by irradiating ultraviolet light-irradiated facing surfaces of a pair of resin base materials with visible light, and electrons move to another polymer contained in the resin base material, and thus the fluorescent molecules become nonfluorescent molecules. Thereby, the fluorescence of the microchip can be reduced.

### BRIEF DESCRIPTION OF THE DRAWINGS

FIGS. 1A to 1C are configuration diagrams showing a microchip that is created using a manufacturing method of the present invention; FIG. 1A is a plan view, FIG. 1B is a side view, and FIG. 1C is a cross-sectional view taken along line I-I of FIG. 1A;

FIGS. 2A to 2D are diagrams showing an example of a method of manufacturing a microchip according to a first embodiment of the present invention, and are configuration diagrams showing an ultraviolet light process, a bonding process, and a visible light process;

FIG. 3 is a graph showing a relative light intensity with respect to a wavelength of visible light used in the visible light process of the method of manufacturing a microchip according to the first embodiment of the present invention;

FIGS. 4A and 4B are graphs showing a relative light intensity with respect to a wavelength in another light source; FIG. 4A shows an example of light of an LED light source, and FIG. 4B shows natural light (daylight);

FIG. 5 shows measurement results of Example 1 using the method of manufacturing a microchip according to the first embodiment of the present invention, and is a graph obtained by measuring a fluorescence spectrum with respect to a wavelength;

FIGS. 6A to 6E are diagrams showing an example of a method of manufacturing a microchip according to a second embodiment of the present invention, and are configuration diagrams showing an ultraviolet light process, a visible light process, and a bonding process;

FIG. 7 shows measurement results of Example 2 using the method of manufacturing a microchip according to the second embodiment of the present invention, and is a graph obtained by measuring a fluorescence spectrum with respect to a wavelength;

FIGS. 8A to 8E are diagrams showing Modified Example 2 of the method of manufacturing a microchip according to the second embodiment of the present invention, and are configuration diagrams showing an ultraviolet light process, a visible light process, and a bonding process; and

FIGS. 9A and 9B are diagrams showing a method of manufacturing a microchip in an example of the related art, and are schematic diagrams showing a vacuum ultraviolet light treatment process and a bonding process.

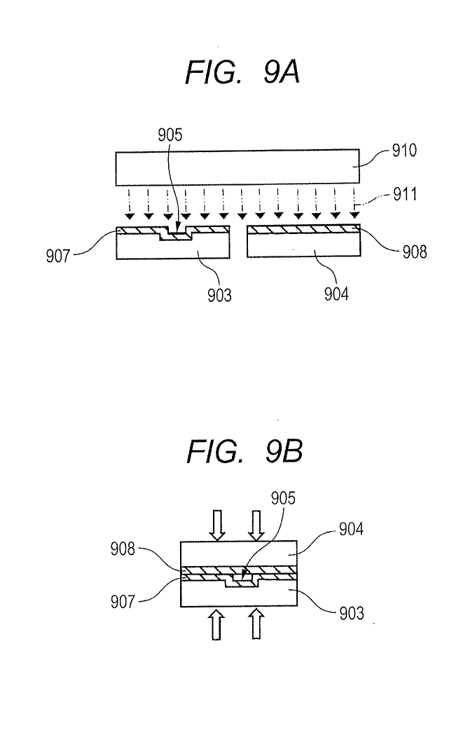

### DESCRIPTION OF THE EXEMPLARY EMBODIMENTS

Hereinafter, embodiments of the present invention will be described in detail with reference to the accompanying drawings.

### First Embodiment

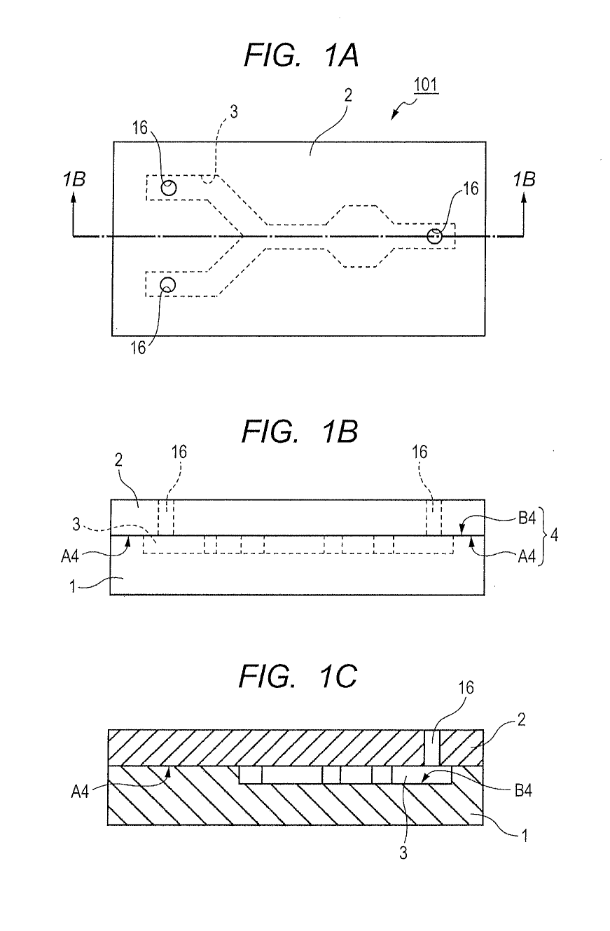

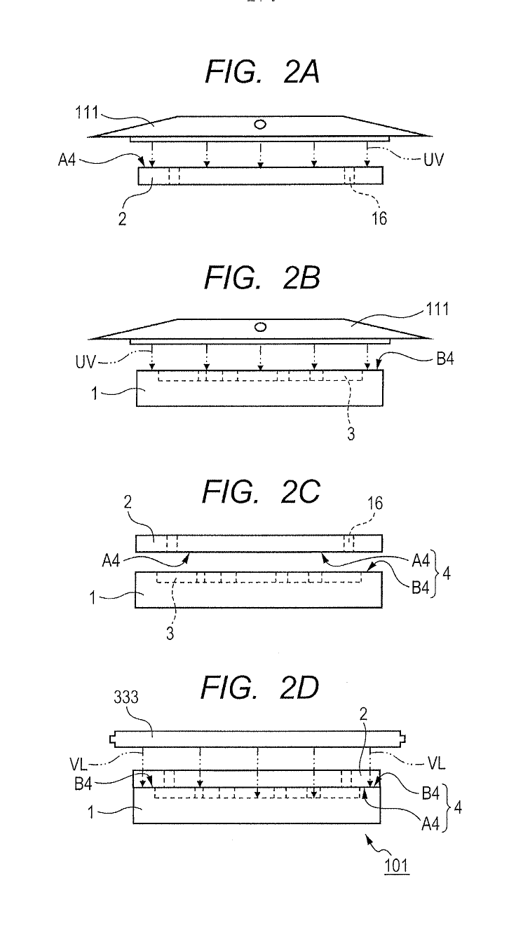

FIGS. 1A to 1C are configuration diagrams showing a microchip 101 that is created using a manufacturing method of the present invention. FIG. 1A is a plan view, FIG. 1B is a side view, and FIG. 1C is a cross-sectional view taken along line I-I of FIG. 1A. FIGS. 2A to 2D are diagrams showing an example of a method of manufacturing the microchip 101 according to a first embodiment of the present invention. FIGS. 2A and 2B are configuration diagrams showing an ultraviolet light process P11 of irradiating a light transmissive base material 2 and a resin base material 1 with ultraviolet light UV. FIG. 2C is a configuration diagram showing the light transmissive base material 2 and the resin base material 1 that are brought to face each other in a bonding process P12 before the base materials are bonded to each other. FIG. 2D is a configuration diagram showing a visible light process P13 of irradiating the microchip 101 with visible light VL.

As shown in FIGS. 1A to 1C, the microchip 101 created using the manufacturing method of the present invention is constituted by a pair of resin base materials in which a fine flow channel is formed by a concave portion 3. The concave portion 3 is formed in one surface of the resin base material 1 which is one resin base material, and facing surfaces 4 of the resin base material 1 and the light transmissive base material 2, which is the other resin base material, are bonded to each other. A plurality of injection holes 16 for injection of a sample are provided in the light transmissive base material 2.

In the visible light process P13 to be described later, it is required that the light transmissive base material 2 is a light transmissive base material through which visible light VL passes. A material such as a cycloolefin polymer (COP), a cycloolefin copolymer (COC), polymethyl methacrylate (PMMA), polycarbonate (PC), polythylene telephthalate (PET), or amorphous polyolefin is used as the light transmissive base material. In particular, the cycloolefin polymer (COP) and the cycloolefin copolymer (COC) are suitably used because these polymers are synthetic resin materials with low intrinsic fluorescence.

In addition, intensity, workability, and adhesion with the light transmissive base material 2 are considered for the resin base material 1. A silicone resin such as a cycloolefin polymer (COP), a cycloolefin copolymer (COC), polymethyl methacrylate (PMMA), polycarbonate (PC), or polydimethylsiloxane (PDMS), or a material such as polythylene telephthalate (PET) or amorphous polyolefin is used as the resin base material. However, similarly to the light transmissive base material 2, the cycloolefin polymer (COP) and the cycloolefin copolymer (COC) are particularly suitably used as the resin base material because these polymers are synthetic resin materials with low intrinsic fluorescence.

Next, a method of manufacturing the microchip 101 will be described.

The method of manufacturing the microchip 101 includes an ultraviolet process P11 of irradiating the facing surfaces 4 before the pair of resin base materials are bonded to each other, with ultraviolet light UV, a bonding process P12 of bringing the facing surfaces 4 after the ultraviolet process P11 into contact with each other to thereby bond the pair of resin base material to each other, and a visible light process P13 of performing irradiation with visible light VL from the light transmissive base material 2 side, which is one resin base material, after the bonding process P12.

First, as shown in FIGS. 2A and 2B, the facing surface 4 (B4) of the resin base material 1 which includes a bonding surface and the facing surface 4 (A4) of the light transmissive base material 2 are irradiated with ultraviolet light UV which is light having a wavelength of an ultraviolet region by using an ultraviolet light lamp 111 (ultraviolet process P11). In particular, it is preferable that vacuum ultraviolet light (VUV), which is ultraviolet light having a wavelength of 100 nm to 200 nm and being capable of expecting the improvement of adhesion performance, be used as the ultraviolet light UV in the bonding process P12 to be described later. In addition, the processes of irradiating the resin base material 1 and the light transmissive base material 2 with ultraviolet light UV may be performed at the same time or separately.

Next, as shown in FIG. 2C, after the ultraviolet light UV-irradiated facing surface B4 of the resin base material 1 and the ultraviolet light UV-irradiated facing surface A4 of the light transmissive base material 2 are caused to face each other, a rise in temperature is performed in a state where the facing surface B4 of the resin base material 1 and the facing surface A4 of the light transmissive base material 2 are brought into contact with each other, thereby bonding the resin base material 1 and the light transmissive base material 2 to each other (bonding process P12). In addition, the rise in temperature in the bonding process P12 is performed at a temperature equal to or less than a glass transition temperature of the synthetic resin material used. However, when the rise in temperature is performed while pressing the facing surfaces 4 of the resin base material 1 and the light transmissive base material 2 in a direction in which the facing surfaces come into close contact with each other, adhesion therebetween further increases, to obtain a more preferable result.

In addition, bonding and sealing methods using an adhesive are also considered as a method of bonding the resin base material 1 and the light transmissive base material 2 to each other. However, since the adhesive itself has a large intrinsic fluorescence, a method using an adhesive is not preferable. In addition, bonding and sealing methods using thermal fusion are also considered. However, since the bonding using these methods is generally performed at a temperature equal to or more than a glass transition temperature of a synthetic resin, a substrate is deformed during the bonding, which results in a loss of a function as a microchip. Further, the influence of the substrate deformation becomes more conspicuous when the width of the flow channel is reduced or when a flow channel pattern is formed complicated in shape, and thus it is difficult to obtain a highly-functional microchip in the bonding using thermal fusion.

Finally, as shown in FIG. 2D, the microchip 101 after the bonding process P12 is irradiated with visible light VL including light having a wavelength of a visible region from the light transmissive base material 2 side, by using a visible light lamp 333 (visible light process P13). Since the light transmissive base material 2 is a base material having a light transmitting property through which visible light VL passes, the ultraviolet light UV-irradiated facing surface B4 of the resin base material 1 which includes the concave portion 3 and the ultraviolet light UV-irradiated facing surface A4 of the light transmissive base material 2 are irradiated with visible light VL. Thereby, fluorescent molecules with a fluorescent property which are generated by ultraviolet light UV are in an excited state by irradiating the ultraviolet light UV-irradiated facing surface B4 of the resin base material 1 which includes the concave portion 3 and the ultraviolet light UV-irradiated facing surface A4 of the light transmissive base material 2 with visible light VL, and thus electrons move to another polymer contained in each synthetic resin substrate, and thus the fluorescent molecules become nonfluorescent molecules. Thereby, the fluorescence of the microchip 101 can be reduced.

In addition, when the visible light VL is irradiated in the visible light process P13, the visible light lamp 333 may be used together with an ultraviolet light cut filter that cuts light having a wavelength of equal to or less than 380 nm. Thereby, the light emitted onto the facing surface B4 of the resin base material 1 which includes the concave portion 3 and the facing surface A4 of the light transmissive base material 2 is visible light VL that substantially includes light having a wavelength of 380 nm to 800 nm which includes little ultraviolet light. For this reason, the fluorescent molecules generated in the ultraviolet process P11 can be reliably used as nonfluorescent molecules without newly generating fluorescent molecules with a fluorescent property which are generated by irradiation with ultraviolet light UV. Thereby, the fluorescence of the microchip 101 can be further reduced.

In addition, in the method of manufacturing the microchip 101, the bonding process P12 is performed after the ultraviolet process P11, and the visible light process P13 of performing irradiation with visible light VL after the bonding process P12 is performed. Thereby, the fluorescent molecules with a fluorescent property which are generated by ultraviolet light UV can be reliably used as nonfluorescent molecules, and the resin base material 1 and the light transmissive base material 2 can be reliably bonded to each other without decreasing the adhesion between the resin base material 1 and the light transmissive base material 2. Thereby, it is possible to further reduce the fluorescence of the microchip 101 and to create the microchip 101 that is excellent in pressure resistance, and the like.

### Example 1

Hereinafter, the first embodiment of the present invention will be described in more detail by Example 1. The present invention is not limited to the example below.

First, as the resin base material 1 and the light transmissive base material 2, a pair of resin base materials (70 mm×20 mm, thickness of 2 mm) constituted by a cycloolefin polymer (manufactured by Nippon Zeon Co., Ltd., ZEONEX330R, glass transition temperature of 123° C.) were used. The concave portion 3 of the resin base material 1 and the injection holes 16 of the light transmissive base material 2 were created by performing machining on the resin base materials.

Next, each of the surfaces of the facing surface B4 of the resin base material 1 and the facing surface A4 of the light transmissive base material 2 was irradiated with ultraviolet light UV (wavelength of 172 nm) by using an Xe excimer lamp (manufactured by Ushio Inc., UER20-172A). The irradiation with ultraviolet light UV is performed in the air. A distance between the lamp and the surface of the resin base material 1 and a distance between the lamp and the surface of the light transmissive base material 2 were set to 5 mm, irradiation intensity was set to 10 mW/cm2, and an irradiation time was set to 60 minutes. A surface to be irradiated with ultraviolet light UV was used as the entirety of each of bonding surfaces to be bonded.

Next, the ultraviolet light UV-irradiated surfaces of the resin base material 1 and the light transmissive base material 2 after the ultraviolet process P11 were caused to face each other and to come into contact with each other, and the temperature of the entirety was increased to 100° C. while performing pressing on the entirety with pressure of 0.7 MPa in a direction in which the ultraviolet light UV-irradiated surfaces come into close contact with each other, and this state was maintained for one hour. Thereafter, after the temperature of the entirety was reduced up to a room temperature, the above-mentioned pressing was stopped, and it was confirmed whether or not the substrates are bonded to each other. As a result, the substrates are firmly bonded to each other, and thus it was not possible to detach them from each other without damage.

Meanwhile, even when a resin base material constituted by a cycloolefin polymer (manufactured by Nippon Zeon Co., Ltd., ZEONEX480R, glass transition temperature of 138° C.) which is different from the above was used, and even when a resin base material constituted by polycarbonate (manufactured by Bayer AG, glass transition temperature of 210° C.) was used, the same results were obtained. In addition, even when the irradiation time of ultraviolet light UV was set to 5 minutes, the same results were obtained.

Finally, the microchip 101 after the bonding process P12 was irradiated with visible light VL that substantially includes light having a wavelength of a visible region from the light transmissive base material 2 side, by using a xenon lamp (manufactured by Asahi Spectra Co., Ltd., LAX-1000). The irradiation with visible light VL was performed in dry air. A distance between the lamp and the surface of the resin base material 1 and a distance between the lamp and the surface of the light transmissive base material 2 were set to 5 cm, irradiation intensity was set to 50 mW/cm2, and an irradiation time was set to 10 minutes. As other conditions, under conditions in which the irradiation intensity was set to 167 mW/cm2 and the irradiation time was set to 10 minutes, the above-mentioned irradiation was performed on another microchip sample.

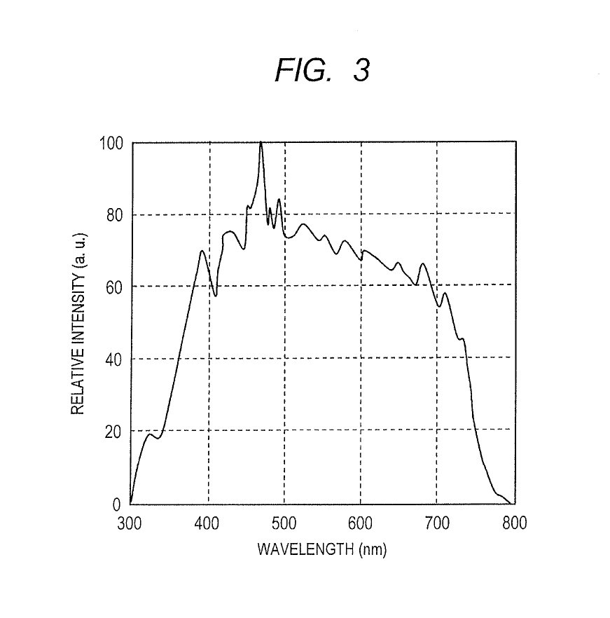

FIG. 3 is a graph showing a relative light intensity with respect to a wavelength of the visible light VL used in the visible light process P13 of the method of manufacturing the microchip 101 according to the first embodiment of the present invention. As shown in FIG. 3, since the visible light VL of the xenon lamp used is light of a visible region including a portion of ultraviolet light having a wavelength of equal to or less than 380 nm, it is more preferable to jointly use an ultraviolet light cut filter that cuts light having a wavelength of equal to or less than 380 nm. In practice, an ultraviolet light cut filter that cuts light having a wavelength of equal to or less than 400 nm was used.

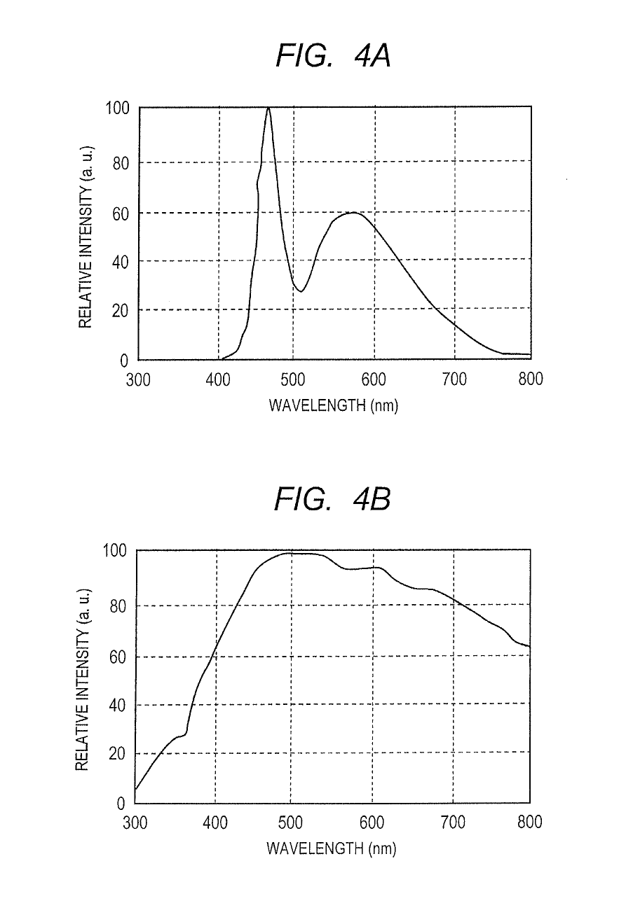

In addition, FIGS. 4A and 4B are graphs showing a relative light intensity with respect to a wavelength in another light source. FIG. 4A shows an example of light of an LED light source, and FIG. 4B shows natural light (daylight). As shown in FIGS. 4A and 4B, it is possible to use LED light including little ultraviolet light, and natural light in which an ultraviolet light cut filter is jointly used. However, in order for both the LED light and the natural light to show irradiation intensity of equal to or more than 10 mW/cm2, a multiple light source has to be used by collecting a large number of light sources, or a condensing system for condensing which has lenses combined with each other has to be used. Furthermore, since the natural light is light including even a great deal of infrared light, visible light as used in Example 1 is more preferably used.

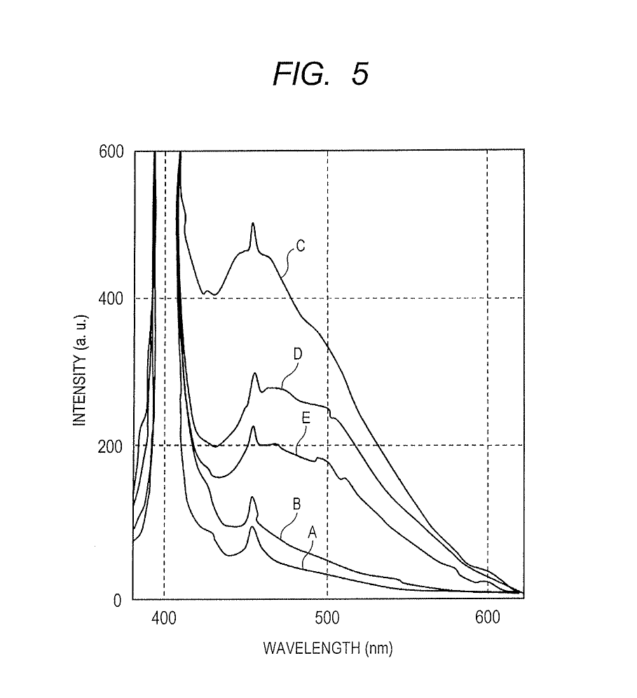

FIG. 5 shows measurement results of Example 1 using the method of manufacturing the microchip 101 according to the first embodiment of the present invention, and is a graph obtained by measuring a fluorescence spectrum with respect to a wavelength. In the graph, A and B indicate the intrinsic fluorescence intensity of the resin base material 1 and the light transmissive base material 2 before the irradiation with ultraviolet light UV, C indicates the fluorescence intensity of the microchip 101 irradiated with ultraviolet light UV after the bonding process P12, D indicates the fluorescence intensity of the microchip 101 after the visible light process P13 under the conditions (irradiation intensity of 50 mW/cm2, irradiation time of 10 minutes), and E indicates the fluorescence intensity of the microchip 101 after the visible light process P13 under other conditions (irradiation intensity of 167 mW/cm2, irradiation time of 10 minutes).

As shown in FIG. 5, in C, as compared with A and B, the fluorescence intensity increases in a band from about 420 nm to about 600 nm by the irradiation with ultraviolet light UV. In D and E, as compared with C, the fluorescence intensity decreases by the irradiation with visible light VL. Therefore, it may be said that the fluorescence of the microchip 101 can be reduced by irradiating the microchip 101, including fluorescent molecules with a fluorescent property which are generated by ultraviolet light UV, with visible light VL. In addition, the fluorescence intensity of the side of E having a higher irradiation intensity in the visible light process P13 is further reduced than that of D, and thus it may be said that the side having a higher irradiation intensity has a greater effect.

As described above, in the method of manufacturing the microchip 101 of the present invention, the fluorescent molecules with a fluorescent property which are generated by ultraviolet light UV are in an excited state by irradiating the ultraviolet light UV-irradiated facing surface B4 of the resin base material 1 and the ultraviolet light UV-irradiated facing surface A4 of the light transmissive base material 2 with visible light VL, and electrons move to another polymer contained in each synthetic resin material, and thus the fluorescent molecules become nonfluorescent molecules. Thereby, the fluorescence of the microchip 101 can be reduced.

In addition, since the visible light VL substantially includes light having a wavelength of 380 nm to 800 nm which includes little ultraviolet light, the fluorescent molecules generated in the ultraviolet process P11 can be reliably used as nonfluorescent molecules without newly generating fluorescent molecules with a fluorescent property which are generated by irradiation with ultraviolet light UV. Thereby, the fluorescence of the microchip 101 can be further reduced.

In addition, the bonding process P12 is performed after the ultraviolet process P11, and the visible light process P13 of performing irradiation with visible light VL after the bonding process P12 is performed. Thus, the fluorescent molecules with a fluorescent property which are generated by ultraviolet light UV can be reliably used as nonfluorescent molecules, and the resin base material 1 and the light transmissive base material 2 can be reliably bonded to each other without decreasing the adhesion between the resin base material 1 and the light transmissive base material 2. Thereby, it is possible to further reduce the fluorescence of the microchip 101 and to create the microchip 101 that is excellent in pressure resistance, and the like.

In addition, since the resin base material is a cycloolefin polymer with low intrinsic fluorescence, the fluorescent molecules with a fluorescent property which are generated by ultraviolet light UV can be reliably used as nonfluorescent molecules. Thereby, the fluorescence of the microchip 101 can be further reduced.

### Second Embodiment

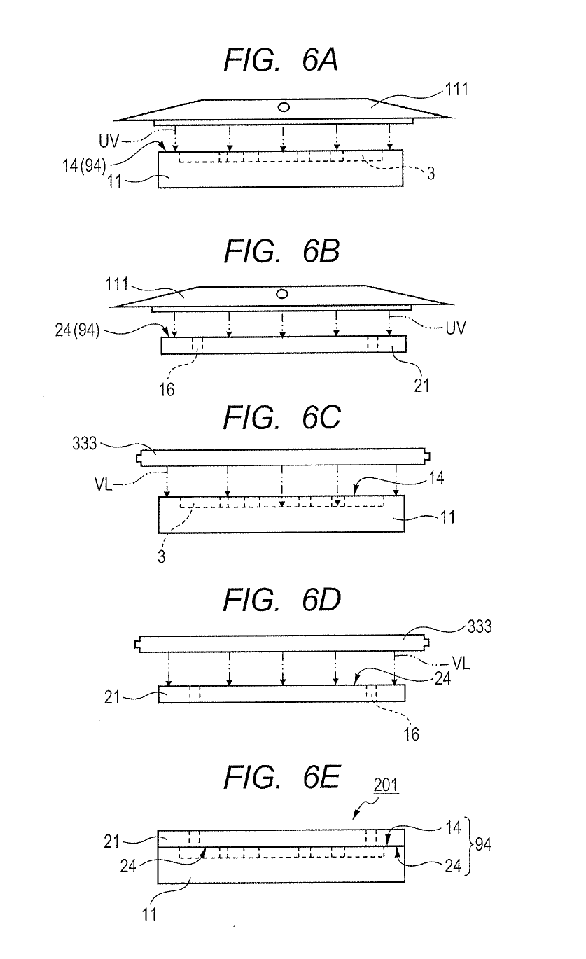

FIGS. 6A to 6E are diagrams showing an example of a method of manufacturing a microchip 201 according to a second embodiment of the present invention. FIGS. 6A and 6B are configuration diagrams showing an ultraviolet light process PU1 of irradiating a pair of resin base materials with ultraviolet light UV, FIGS. 6C and 6D are configuration diagrams showing a visible light process PV2 of irradiating facing surfaces 94 of the pair of resin base materials after the ultraviolet light process PU1, with visible light VL, and FIG. 6E is a configuration diagram showing the microchip 201 after a bonding process PA3. Meanwhile, the same components as those of the first embodiment are denoted by the same reference numerals, and the description thereof will not be repeated.

The method of manufacturing the microchip 201 according to the second embodiment of the present invention includes the ultraviolet light process PU1 of irradiating the facing surfaces 94 before the pair of resin base materials are bonded to each other, with ultraviolet light UV, the visible light process PV2 of irradiating the ultraviolet light UV-irradiated facing surface 94 of the pair of resin base materials, with visible light VL, and the bonding process PA3 of bringing the facing surfaces 94 after the visible light process PV2 into contact with each other to thereby bond the pair of resin base materials to each other.

First, a first resin base material 11 and a second resin base material 21 which are a pair of resin base materials are prepared. The concave portion 3 serving as a fine flow channel is formed in one surface of the first resin base material 11, and the plurality of injection holes 16 for injection of a sample are formed in the second resin base material 21.

In addition, intensity, workability, adhesion between the resin base materials, and the like are considered for the first resin base material 11 and the second resin base material 21. A silicone resin such as a cycloolefin copolymer (COC), a cycloolefin polymer (COP), polymethyl methacrylate (PMMA), polycarbonate (PC), or polydimethylsiloxane (PDMS), or a material such as polythylene telephthalate (PET) or amorphous polyolefin is used as the first resin base material and the second resin base material. In particular, the cycloolefin copolymer (COC) and the cycloolefin polymer (COP) are suitably used because these polymers are synthetic resin materials with low intrinsic fluorescence.

Next, as shown in FIGS. 6A and 6B, the facing surfaces 94 before the pair of resin base materials (the first resin base material 11, the second resin base material 21) are bonded to each other, that is, a first surface 14 and a second surface 24, are irradiated with ultraviolet light UV which is light having a wavelength of an ultraviolet region, by using the ultraviolet light lamp 111 (ultraviolet light process PU1).

Next, as shown in FIGS. 6C and 6D, the first surface 14 of the first resin base material 11 which includes the concave portion 3 and the second surface 24 of the second resin base material 21 after the ultraviolet light process PU1 are irradiated with visible light VL which includes light having a wavelength of a visible region, by using the visible light lamp 333 (visible light process PV2).

Finally, after the visible light VL-irradiated first surface 14 including the concave portion 3 and the visible light VL-irradiated second surface 24 are caused to face each other, a rise in temperature is performed in a state where the first surface 14 and the second surface 24 are brought into contact with each other, thereby bonding the first resin base material 11 and the second resin base material 21 to each other (bonding process PA3). Accordingly, as shown in FIG. 6E, the microchip 201 is obtained. Thereby, the visible light process PV2 of irradiating the ultraviolet light UV-irradiated first surface 14 of the first resin base material 11 which includes the concave portion 3 and the ultraviolet light UV-irradiated second surface 24 of the second resin base material 21 with visible light VL is performed after the ultraviolet light process PU1, and the bonding process PA3 is performed after the visible light process PV2, and thus the fluorescent molecules with a fluorescent property which are generated by ultraviolet light UV can be reliably used as nonfluorescent molecules. Thereby, the fluorescence of the microchip 201 can be further reduced.

### Example 2

Hereinafter, the second embodiment of the present invention will be described in more detail using Example 2. The present invention is not limited to the example below.

First, as the first resin base material 11 and the second resin base material 21, a pair of resin base materials (30 mm×30 mm, thickness of 1.5 mm) constituted by a cycloolefin copolymer (manufactured by Polyplastics Co., Ltd., TOPAS5013L-10, glass transition temperature of 134° C.) were used. The first resin base material 11 and the second resin base material 21 were created by injection molding using a mold for forming the concave portion 3 of the first resin base material 11 and the injection holes 16 of the second resin base material 21.

Next, each of the surfaces of the first surface 14 of the first resin base material 11 and the second surface 24 of the second resin base material 21 was irradiated with ultraviolet light UV (wavelength of 172 nm) by using an Xe excimer lamp (manufactured by Ushio Inc., UER20-172A). The irradiation with ultraviolet light UV was performed in a nitrogen atmosphere. A distance between the lamp and the surface of the first resin base material 11 and a distance between the lamp and the surface of the second resin base material 21 were set to 5 mm, irradiation intensity was set to 10 mW/cm2, and an irradiation time was set to 20 minutes. A surface to be irradiated with ultraviolet light UV was used as the entirety of each of bonding surfaces to be bonded.

Next, the first surface 14 of the first resin base material 11 which includes the concave portion 3 and the second surface 24 of the second resin base material 21 after the ultraviolet light process PU1 were irradiated with visible light VL that substantially includes light having a wavelength of a visible region, by using a xenon lamp (manufactured by Asahi Spectra Co., Ltd., LAX-1000). The irradiation with visible light VL is performed under dry air. A distance between the lamp and the surface of the first resin base material 11 and a distance between the lamp and the surface of the second resin base material 21 were set to 5 cm, irradiation intensity was set to 78 mW/cm2, and an irradiation time was set to 10 minutes. As other conditions, the irradiation with visible light VL was performed on another microchip sample in a nitrogen atmosphere. In addition, as the visible light VL, light of a visible region including a portion of ultraviolet light having a wavelength of equal to or less than 380 nm as shown in FIG. 3 is used.

Finally, the ultraviolet light UV-irradiated surfaces of the first resin base material 11 and the second resin base material 21 after the visible light process PV2 were caused to face each other and to come into contact with each other, and the temperature of the entirety was increased to 100° C. while performing pressing on the entirety with pressure of 0.7 MPa in a direction in which the ultraviolet light UV-irradiated surfaces come into close contact with each other, and this state was maintained for one hour. Thereafter, after the temperature of the entirety is reduced up to a room temperature, the above-mentioned pressing is stopped, and it is confirmed whether or not the resin base materials are bonded to each other. As a result, the resin base materials are firmly bonded to each other, and thus it is not possible to detach them from each other without damage.

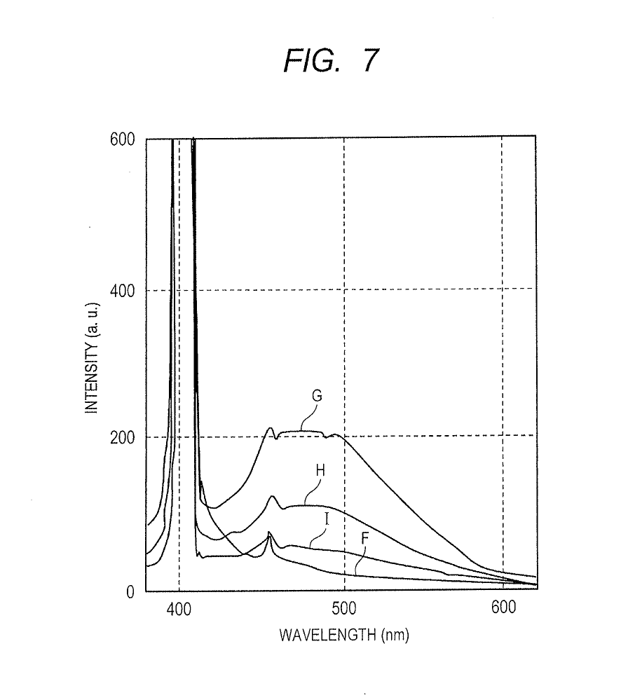

FIG. 7 shows measurement results of Example 2 using the method of manufacturing the microchip 201 according to the second embodiment of the present invention, and is a graph obtained by measuring a fluorescence spectrum with respect to a wavelength. In the graph, F indicates the intrinsic fluorescence intensity of the first resin base material 11 before the irradiation with ultraviolet light UV, G indicates the fluorescence intensity of the first resin base material 11 after the irradiation with ultraviolet light UV, H indicates the fluorescence intensity of the first resin base material 11 after the visible light process PV2 under the conditions (irradiation intensity of 78 mW/cm2, irradiation time of 10 minutes, in dry air), and I indicates the fluorescence intensity of the first resin base material 11 after the visible light process PV2 under other conditions (irradiation intensity of 78 mW/cm2, irradiation time of 10 minutes, in nitrogen atmosphere).

As shown in FIG. 7, in G, as compared with F, the fluorescence intensity increases in a band from about 420 nm to about 600 nm by the irradiation with ultraviolet light UV. In H and I, as compared with G, the fluorescence intensity decreases by the irradiation with visible light VL. In addition, the fluorescence intensity of the side of I in which the irradiation is performed in a nitrogen atmosphere is further reduced than that of H, and thus it may be said that the side in which the irradiation is performed in a nitrogen atmosphere has a greater effect.

As described above, in the method of manufacturing the microchip 201 of the present invention, the fluorescent molecules with a fluorescent property which are generated by ultraviolet light UV are in an excited state by irradiating the ultraviolet light UV-irradiated first surface 14 of the first resin base material 11 and the ultraviolet light UV-irradiated second surface 24 of the second resin base material 21 with visible light VL, and electrons move to another polymer contained in each synthetic resin material, and thus the fluorescent molecules become nonfluorescent molecules. Thereby, the fluorescence of the microchip 201 can be reduced.

In addition, since the visible light VL substantially includes light having a wavelength of 380 nm to 800 nm, the fluorescent molecules generated in the ultraviolet light process PU1 can be reliably used as nonfluorescent molecules without newly generating fluorescent molecules with a fluorescent property which are generated by irradiation with ultraviolet light UV. Thereby, the fluorescence of the microchip 201 can be further reduced.

In addition, the visible light process PV2 is performed of irradiating the ultraviolet light UV-irradiated first surface 14 of the first resin base material 11 and the ultraviolet light UV-irradiated second surface 24 of the second resin base material 21 with visible light VL after the ultraviolet light process PU1, and the bonding process PA3 is performed after the visible light process PV2. Thus, the fluorescent molecules with a fluorescent property, which are generated by ultraviolet light UV, can be reliably used as nonfluorescent molecules. Thereby, the fluorescence of the microchip 201 can be further reduced.

In addition, since the resin base material is a cycloolefin copolymer (COC) with low intrinsic fluorescence, the fluorescent molecules with a fluorescent property, which are generated by ultraviolet light UV, can be reliably used as nonfluorescent molecules. Thereby, the fluorescence of the microchip 201 can be further reduced.

Meanwhile, the present invention is not limited to the above-mentioned embodiments. For example, the present invention can be modified and embodied as follows, and these embodiments are within the scope of the present invention.

### Modified Example 1

In the above-mentioned first embodiment, although the concave portion 3 is formed in the resin base material 1 and the injection holes 16 are formed in the light transmissive base material 2, the injection holes 16 may be formed in the resin base material 1 and the concave portion 3 may be formed in the light transmissive base material 2. In addition, the concave portion 3 may be provided in both the resin base material 1 and the light transmissive base material 2. In addition, the concave portion 3 and the injection hole 16 may be provided in any one of the resin base material 1 and the light transmissive base material 2.

### Modified Example 2

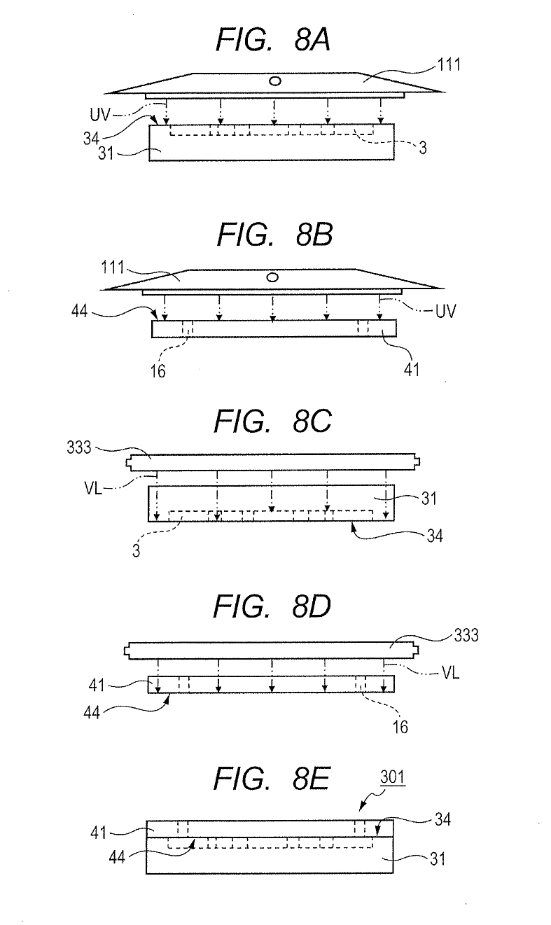

FIGS. 8A to 8E are configuration diagrams showing Modified Example 2 of the method of manufacturing the microchip 201 according to the second embodiment of the present invention. FIGS. 8A and 8B show the ultraviolet light process PU1 of irradiating a first surface 34 of a first resin base material 31 and a second surface 44 of a second resin base material 41 with ultraviolet light UV. FIGS. 8C and 8D show the visible light process PV2 of irradiating the first resin base material 31 and the second resin base material 41 with visible light VL. FIG. 8E is a configuration diagram showing a microchip 301 that is obtained after the bonding process PA3.

In Modified Example 2, a light transmissive base material is used as the first resin base material 31 and the second resin base material 41. Thereby, in the above-mentioned second embodiment, the first surface 14 including the concave portion 3 and the second surface 24 are irradiated with visible light VL in the visible light process PV2, as shown in FIGS. 6C and 6D. However, as shown in FIGS. 8C and 8D, the first surface 34 of the first resin base material 31 which includes the concave portion 3 and the second surface 44 of the second resin base material 41 may be irradiated with visible light VL by causing the light to pass through each of the base materials.

The present invention is not limited to the above-mentioned embodiments, but can be appropriately changed without departing from the scope of the present invention.

It should be understood by those skilled in the art that various modifications, combinations, sub-combinations and alterations may occur depending on design requirements and other factors insofar as they are within the scope of the appended claims of the equivalents thereof.

What is claimed is:

1. A method of manufacturing a microchip from a pair of resin base materials of which facing surfaces are to be bonded to each other and that has a concave portion formed in at least one of the facing surfaces, the method comprising:
irradiating the facing surfaces of the pair of resin base materials, before the pair of resin base materials are bonded to each other, with ultraviolet light which is light having a wavelength of an ultraviolet region,
then irradiating the ultraviolet light-irradiated facing surfaces of the pair of resin base materials, with visible light that substantially includes light having a wavelength of a visible region; and
then bonding the facing surfaces of the pair of resin base materials.

2. The method of manufacturing a microchip according to claim 1, wherein the visible light is light from a light source which substantially includes light having a wavelength of 380 nm to 800 nm.

3. The method of manufacturing a microchip, according to claim 1,
wherein at least any one of the pair of resin base materials is a light transmissive base material through which the visible light passes, and
wherein the method further comprises:
an ultraviolet light process of irradiating the facing surfaces before the pair of resin base materials are bonded to each other, with the ultraviolet light;
a bonding process of bringing the facing surfaces after the ultraviolet light process into contact with each other to thereby bond the pair of resin base materials to each other; and
a visible light process of performing irradiation with the visible light from the light transmissive base material side after the bonding process.

4. The method of manufacturing a microchip according to claim 1, further comprising:
an ultraviolet light process of irradiating the facing surfaces before the pair of resin base materials are bonded to each other, with the ultraviolet light;
a visible light process of irradiating the ultraviolet light-irradiated facing surfaces of the pair of resin base materials, with the visible light; and
a bonding process of bringing the facing surfaces after the visible light process into contact with each other to thereby bond the pair of resin base materials to each other.

5. The method of manufacturing a microchip according to claim 1, wherein at least any one of the resin base materials is one of a cycloolefin polymer or a cycloolefin copolymer.
